(19) United States
(12) Patent Application Publication
(10) Pub. No.: US 2025/0388168 A1
(43) Pub. Date: Dec. 25, 2025

(54) LIGHTING ASSEMBLY FOR A RECREATIONAL TRAVEL TRAILER AND SYSTEM THEREOF

(71) Applicant: FOREST RIVER, INC., Elkhart, IN (US)

(72) Inventor: Ira Mullet, Shipshewana, IN (US)

(21) Appl. No.: 19/244,130

(22) Filed: Jun. 20, 2025

Related U.S. Application Data
(60) Provisional application No. 63/663,410, filed on Jun. 24, 2024.

(51) Int. Cl. B60Q 3/51; B60P 3/32; B60Q 3/82

(52) U.S. Cl. CPC B60Q 3/51; B60P 3/32; B60Q 3/82

(57) ABSTRACT

A recreational travel trailer includes a chassis and a body supported by the chassis. The body includes one or more walls and a roof structure. A ceiling is located in an interior of the living space and aligned but spaced from the roof structure. A lighting assembly is disposed within an opening in the ceiling, the light assembly having a fixture and a bulb for illuminating the interior. The fixture is coupled to the ceiling.

### RELATED DISCLOSURES

This application claims the benefit of U.S. Provisional Patent Application Ser. No. 63/663,410, filed Jun. 24, 2024, the disclosure of which is hereby incorporated by reference in its entirety.

### FIELD OF THE DISCLOSURE

The present disclosure relates to a travel trailer, and more particularly to a lighting assembly for a recreational travel trailer.

### BACKGROUND

Recreational fifth wheel travel trailers provide individuals with spacious, comfortable and transportable lodging. In particular, a typical fifth wheel travel trailer comprises a housing member having a multi-level interior living space formed therein, a multi-level chassis adapted to support the housing member, and a carriage member having a plurality of wheels interposed between the chassis and a supporting surface so as to enable the trailer to travel on the supporting surface. Furthermore, the typical fifth wheel trailer is adapted to detachably mount to a towing vehicle so that a front end of the trailer extends beyond the load bearing rear wheels of the towing vehicle so as to enable the towing vehicle to essentially act as a fifth wheel.

Since fifth wheel trailers are currently available with lengths as great as forty-five feet (and possibly longer) and pop-out sections that provide the housing member with increased width, their interior living spaces are able to resemble that of a nicely appointed home. For example, a fifth wheel travel trailer can include a large kitchen, a large bathroom, a large bedroom, and a large living area. Moreover, these trailers typically include multiple water storage tanks for supplying hot and cold water as well as for storing wastewater, wiring for distributing electrical power and a central heating/ventilation/air conditioning (HVAC) system for providing desirable environmental conditions within the interior living space.

### SUMMARY

In a first implementation of the present disclosure, a recreational vehicle includes a chassis; a body supported by the chassis and forming an interior of a living space, the body including one or more walls and a roof structure; a ceiling located in the interior of the living space, the ceiling aligned but spaced from the roof structure; a lighting assembly disposed within an opening recessed in the ceiling, the light assembly including a fixture and a bulb for illuminating the interior; wherein, the fixture is coupled to the ceiling.

In one example of this implementation, the lighting assembly includes a frame positioned within the opening, the light fixture being coupled to the frame. In a second example, the frame is coupled to the ceiling via welding, an adhesive, or a mechanical coupling. In a third example, a mounting bracket is configured to couple the frame and light fixture to one another. In a fourth example, the frame is coupled to the ceiling and roof structure. In a fifth example, the frame is partially located in a space defined between the roof structure and ceiling.

In a sixth example, the light fixture is directly coupled to the roof structure. In a seventh example, the bulb includes a LED, halogen, fluorescent, or incandescent bulb. In an eighth example, the light fixture includes an outer support frame including a plurality of openings. In another example, the light fixture forms an inner cavity configured to receive the bulb. In a further example, the opening formed in the ceiling has a first perimeter and the outer support frame has a second perimeter, the second perimeter being greater than the first perimeter.

In another implementation of the present disclosure, a sky light assembly for being coupled to a ceiling in a recreational vehicle includes a frame configured to being coupled to an opening formed in the ceiling; a light fixture coupled to the frame, the light fixture including an outer support frame and an inner cavity; a bulb disposed within the inner cavity, the bulb coupled to the light fixture; and a mounting bracket configured to couple the light fixture to the frame.

In one example of this implementation, the frame includes a rectangular shape, a square shape, an oval shape, a circular shape, or polygonal shape. In another example, a control assembly includes a controller and a power source, the power source being operably coupled to the controller; wherein, the power source is electrically coupled to the bulb; wherein, the controller is configured to control power to the bulb via the power source. In another example, a user control is disposed in communication with the controller, the user control configured to control a transmittal of electrical power to the bulb. In yet another example, a sensor is disposed in communication with the controller, the sensor configured to detect a characteristic and send a signal to the controller in response to the characteristic. In a further example, the controller is configured to control an amount of power delivered to the bulb based on the signal from the sensor. In yet another example, the controller is configured to execute control logic to control an amount of power being sent from the power source to the bulb.

In a further implementation of the present disclosure, a recreational vehicle includes a chassis; a body supported by the chassis and forming an interior of a living space, the body including one or more walls and a roof structure; a ceiling located in the interior of the living space, the ceiling aligned but spaced from the roof structure to form a gap therebetween; and a sky light assembly disposed within an opening formed in the ceiling and the roof structure, the sky light assembly including a frame, a light fixture, a bulb for illuminating the interior, a controller, a power source, and a mounting bracket; wherein, the frame is coupled to the opening formed in the ceiling and roof structure; wherein, the mounting bracket couples the frame and light fixture to one another; wherein, the power source is operably coupled to the controller and electrically coupled to the bulb, where the controller is configured to control an amount of power transmitted to the bulb via the power source.

In one example of this implementation, the light fixture includes an outer support frame and an inner cavity, where the bulb is disposed within the inner cavity and coupled to the light fixture.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of a fifth wheel travel trailer;

FIG. 2 is a schematic of a lighting assembly for a recreational travel trailer;

FIG. 3 is a front view of a fixture of the lighting assembly of FIG. 2;

FIG. 4 is a front and side schematic views of the lighting assembly of FIG. 2; and

FIG. 5 is an interior of a recreational travel trailer with a lighting assembly installed therein.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

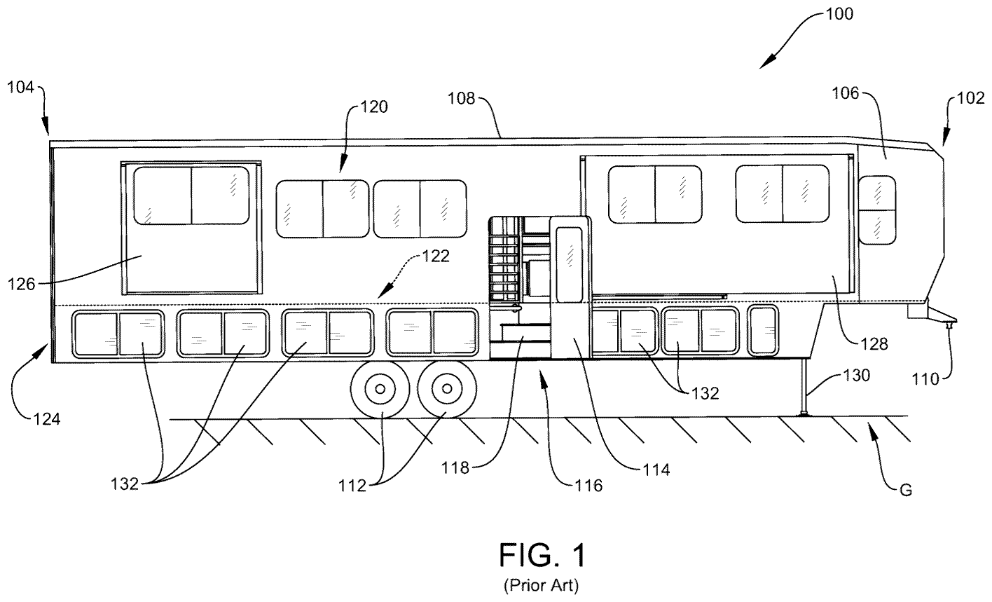

Referring to FIG. 1, an embodiment of a fifth wheel travel trailer or recreational vehicle 100 is illustrated. This trailer or recreational vehicle 100 may include a front end 102 and a rear end 104. For instance, an interior floor 122 of the trailer or recreational vehicle 100 may lie along a substantially horizontal plane between the front 102 and rear 104 thereof. The single-level trailer or recreational vehicle 100 may be formed as a body 106 supported by a frame assembly or chassis (not shown). The frame assembly or chassis may be a drop frame assembly or a straight frame assembly. The body 106 and frame assembly may be further supported by one or more wheels 112.

The body 106 may include an overhead roof 108 as shown in FIG. 1. Further, a hitch 110 may be located at the front end 102 of the trailer or recreational vehicle 100 for coupling to a towing vehicle (not shown). When the trailer or recreational vehicle 100 is disconnected from the towing vehicle, a support member 130 or landing gear may be provided to support the front end 102 thereof.

The body 106 may include skirting (not shown). In other embodiments, the trailer or recreational vehicle 100 may not include any skirting.

A door 114 may be coupled to the body 106 to allow access between the interior of the trailer or recreational vehicle 100 and outside thereof. The door 114, when opened, allows access to an entryway 116 which may be accessed by a set of steps 118 between the ground, G, and a living area 120 of the trailer or recreational vehicle 100. In one embodiment, the entryway 116 may have a width greater than the typical 30″ found on some multi-level fifth wheel trailers. For instance, the passageway 116 may have a width between 30-40 inches. In a further example, the width may be between 32-38 inches. In yet a further example, the width may be approximately 36 inches. The present disclosure is not intended to be limited to any type of width of the entryway 116.

The trailer or recreational vehicle 100 may include a first slide out 126 and a second slide out 128. The slide outs, when configured in their deployed positions, allow the single level living area 120 to increase in living space as the side wall of the body 106 moves outwardly a predetermined distance. While the trailer or recreational vehicle 100 of FIG. 1 includes a pair of slide outs, this is not intended to be limiting. The trailer or recreational vehicle 100 may include any number of slide outs for purposes of the present disclosure.

The travel trailer may include a height defined between the floor 122 and ceiling. In some embodiments, the height may be approximately the same throughout, whereas in other embodiments, the height may vary between the front 102 and rear 104. In FIG. 1, a first height, H₁, at the rear 104 of the trailer or recreational vehicle 100 may be approximately, if not exactly, the same as a second height, H₂, at the front 102 thereof. For example, the heights may be up to 84 inches. Conventional multi-level fifth wheel travel trailers having varying heights throughout the interior living spaces depending upon the location therein. For instance, a conventional multi-level fifth wheel may have heights that vary between 75 inches and 105 inches, where the less headroom is normally found in those living spaces that are elevated at the front and/or rear of the trailer.

The floor level 122 may separate the living space 120 of the trailer or recreational vehicle 100 from a storage compartment or basement 124. The storage compartment 124 may be accessed by any one of a plurality of storage doors 132. The storage compartment 124 of the travel trailer or recreational vehicle 100 of FIG. 1 may be individual compartments or a full pass-through storage space that runs continuously (e.g., uninterrupted) from the rear end 104 of the trailer or recreational vehicle 100 to a location towards the front end 102 thereof. In FIG. 1, for example, the storage compartment 124 may be a continuous space defined between point A at the rear 104 and point B towards the front 102. The storage compartment 124 may be formed of a single piece of composite material which can reduce the overall cost of the trailer or recreational vehicle 100. In other embodiments, the storage compartment 124 may be formed of other material besides composite.

In many conventional travel trailers and other recreational vehicles that include lighting assemblies that are formed in the roof or ceiling of the trailer such as a skylight, there are often problems with leaks due to the weather such as from the sun, water, snow and ice. The seal around these lighting assemblies are generally formed from rubber or a similar material, and as the seals get worn or damaged, there can be issues with leakage. Once a leak forms, water can easily get into the travel trailer and create mold issues or other structural damage.

Thus, there is a need for improved leak control and/or prevention in recreational travel trailers as well as other travel trailers (e.g., fifth wheel travel trailers and motorhomes) where there is a skylight or other lighting assembly that is mounted within an opening formed in the roof or ceiling of the trailer. The trailer includes a chassis with a shell or frame built upon the chassis. A roof is mounted to the shell or frame in a conventional manner. A rectangular, square, circular or any other known shape opening may be cut or formed in the roof for the skylight or other lighting assembly to be mounted in a conventional setup.

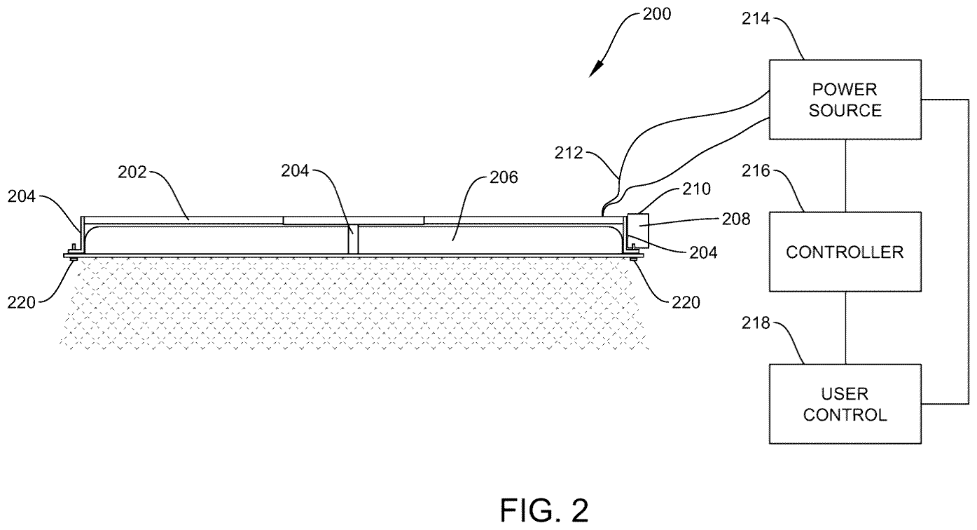

The present disclosure provides one or more implementations for mounting a lighting assembly similar to a skylight in a location in a recreational travel trailer that does not generally include a window or other source of outside light such as a bathroom. In FIG. 2, for example, a lighting assembly 200 is illustrated. The lighting assembly 200 may be mounted or coupled to a roof structure or ceiling 210 on the interior of the trailer. In this arrangement, and unlike conventional travel trailers, the lighting assembly is not disposed within an opening formed in the ceiling or roof of the travel trailer. Instead, a frame 208 may be formed in the location where the lighting assembly 200 is to be coupled. The frame 208 may be welded, adhered, or mechanically fastened to the roof structure or ceiling 210. In the event the lighting assembly 200 has a rectangular shape, the frame 208 may form a rectangular shaped cavity in which the lighting assembly 200 is disposed. Other shapes are also possible such as square, oval, circular, triangular, pentagonal, hexagonal, octagonal, and other known shapes.

In some implementations, the ceiling 210 and roof or roof structure are the same. In other implementations, the roof structure is associated with the overhead roof 108 of the trailer or recreational vehicle 100, and the ceiling 210 is offset or displaced from the roof 108. For example, the roof structure may be located above the ceiling 210. The ceiling 210 is thus lower in a vertical direction from the roof structure such that there is a gap or space therebetween. In any event, the lighting assembly 200 may include a frame 208 configured to be positioned within an opening formed in the roof structure 108 and ceiling 210 regardless of whether the ceiling 210 is aligned with or vertically offset from the roof structure 108.

The lighting assembly 200 may include a light fixture 202 that is coupled to the frame 208 via one or more mounting brackets 204. The mounting bracket 204 may be directly coupled to the light fixture 202 and then fastened or otherwise coupled to the frame 208. In some implementations, the mounting bracket may be coupled to the frame 208 via one or more fasteners 220. The one or more fasteners 220 may include screws, bolts, nails, washers, nuts, etc.

In several implementations, the light fixture 202 may be coupled to the roof structure or ceiling 210. Fasteners 220 may be used in this implementation to couple the light fixture 202 to the roof structure or ceiling 210.

In other implementations, the light fixture 202 may be welded, adhered, or coupled to the roof structure 210 or frame 208. Other known ways of coupling the light fixture 202 are also possible.

The light assembly 200 may include a light or lamp bulb 206 coupled to the light fixture 202. The bulb 206 may be a LED, halogen, fluorescent, and/or incandescent. In some implementations, there may be two or more bulbs 206 per light assembly 200. In other implementations, there may be three or more bulbs 206 per light assembly 200. In yet another implementation, there may be a single bulb 206 per light assembly.

The light assembly 200 may be structured similar to a skylight. A skylight is a window or structure that is installed on a roof to allow natural light into an interior space such as a travel trailer. Although the light assembly 200 is not a natural light source, it may be designed and incorporated into the roof structure 210 of the travel trailer so as to give the appearance of a skylight.

Referring to FIG. 2, the light assembly 200 may include one or more wires 212 that form an electrical conduit to the light assembly. The one or more wires 212 may be electrically coupled to a power source 214. In some implementations, the power source 214 may be an outlet located external of the travel trailer. In other implementations, the power source 214 may be a battery. In yet other implementations, the power source 214 may be a solar panel located on the roof structure of the travel trailer or elsewhere. Other known power sources may be used to electrically power the light assembly 200.

The lighting assembly 200 may be part of overall control system. The control system, as partially illustrated in FIG. 2, may include the power source 214. The power source 214 may be electrically coupled and/or in communication with a controller 216 and user control 218. The user control 218 may be a light switch located in the travel trailer or on a key fob or other remote control device. The controller 216 may be external of the light assembly 200. In other implementations, the controller 216 may be part of the light assembly 200. The controller 216 may receive a communication from the user control 218 and electrically power the light assembly 200. In some implementations, a controller 216 is optional and may not be part of the overall system. In several implementations, the user control 218 may be directly coupled to the power source to communicate whether to illuminate or turn off the light assembly 200.

In some implementations, the controller 216 may be programmed to turn on or off the light assembly 200 at set times in a day. In this manner, the controller 216 may include an internal timer that may be programmable. In other implementations, the controller 216 may include a processing unit and memory unit capable of storing and executing software or control logic. For example, the controller 216 may be programmed to illuminate the lighting assembly 200 whenever a sensor (not shown) detects a presence of a person entering the room or area where the lighting assembly 200 is located. This may be a bedroom or bathroom, for example, in the recreational vehicle. Alternatively, the controller 216 may include a sensor for detecting a characteristic such as dusk or dawn (e.g., a time of day or amount of light or darkness in a given area). Here, the controller 216 may automatically trigger the lighting assembly 200 to illuminate based on a signal from the sensor if the sensor detects it is dusk, dawn, or some other time of day.

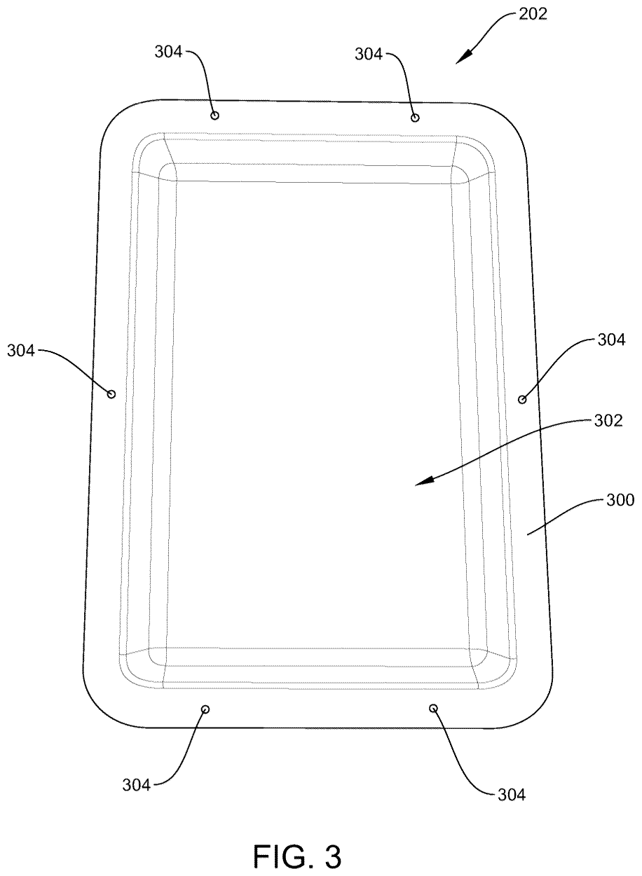

Referring now to FIG. 3 of the present disclosure, one implementation of a light fixture 202 is illustrated. The light fixture 202 may include an outer fixture frame or support frame 300. In this implementation, the outer fixture frame 300 forms an inner cavity 302 in which the light 206 may be disposed. The outer fixture frame 300 may include a plurality of mounting openings 304 for coupling the outer fixture frame 300 to the frame 208. The outer fixture frame 300 may have a shape similar to that of a skylight. In some implementations, the outer fixture frame 300 may be rectangularly shaped. In other implementations, the outer fixture frame 300 may be ovally shaped. In several implementations, the outer fixture frame 300 may be square shaped. Other known shapes are also possible.

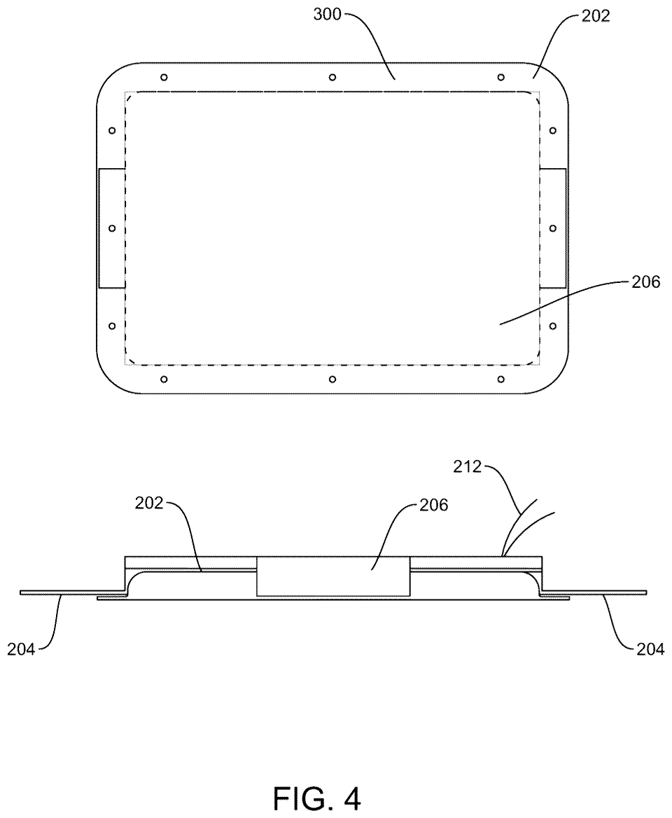

In FIG. 4, the outer fixture frame 300 is shown with the light 206 installed. Further, the mounting brackets 204 are also shown being coupled to the outer fixture frame 300. The outer fixture frame 300 may include one or more openings 304 for the wires 212 to be pulled through.

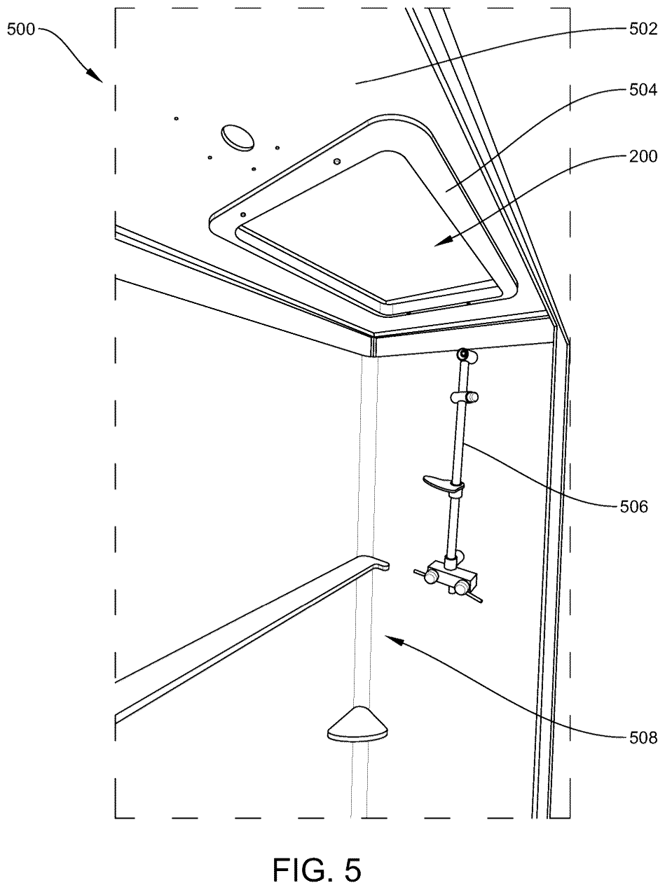

Referring to FIG. 5 of the present disclosure, a portion of a room within a travel trailer is shown. In this implementation, the room is a bathroom 500. The bathroom 500 may include a plurality of walls and a ceiling 502. The bathroom 500 may include a shower 508 and/or tub. The shower 508 may include a shower head and water handles 506 for controlling a valve to turn on or off the water to the shower 508.

As shown in this implementation, a light assembly 200 may be coupled or mounted to the ceiling 502 in a location in which a skylight may be disposed. The light assembly 200 may include a frame and light combination 504 for illuminating the bathroom 500. As shown, the frame may be part of a light fixture 202 as previously described. The light fixture 202 may be installed flush or approximately flush with the ceiling. A recessed opening may be formed in the ceiling 502 to allow the light assembly 200 to be located therein. The recessed opening is only formed in the ceiling and does not extend through the external roof of the travel trailer. In some implementations, the opening may be recessed approximately 2″ into the ceiling. In this way, there is not moisture, water, etc. from leaking into the bathroom 500. Further, no sealant or other fasteners commonly used with skylights is needed. The recessed nature of the light assembly also allows for additional headroom in the bathroom 500 as generally found with skylights. The light assembly 200 is formed to have the appearance of a skylight from inside the bathroom 500, but the light assembly 200 does not have the risk of allowing water to leak into the bathroom 500 as conventional skylights do.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A recreational vehicle, comprising:
a chassis;
a body supported by the chassis and forming an interior of a living space, the body including one or more walls and a roof structure;
a ceiling located in the interior of the living space, the ceiling aligned but spaced from the roof structure;
a lighting assembly disposed within an opening recessed in the ceiling, the light assembly comprising a fixture and a bulb for illuminating the interior;
wherein, the fixture is coupled to the ceiling.

2. The vehicle of claim 1, wherein the lighting assembly comprises a frame positioned within the opening, the light fixture being coupled to the frame.

3. The vehicle of claim 2, wherein the frame is coupled to the ceiling via welding, an adhesive, or a mechanical coupling.

4. The vehicle of claim 2, further comprising a mounting bracket configured to couple the frame and light fixture to one another.

5. The vehicle of claim 2, wherein the frame is coupled to the ceiling and roof structure.

6. The vehicle of claim 5, wherein the frame is partially located in a space defined between the roof structure and ceiling.

7. The vehicle of claim 2, wherein the light fixture is directly coupled to the roof structure.

8. The vehicle of claim 1, wherein the bulb comprises a LED, halogen, fluorescent, or incandescent bulb.

9. The vehicle of claim 1, wherein the light fixture comprises an outer support frame including a plurality of openings.

10. The vehicle of claim 9, wherein the light fixture forms an inner cavity configured to receive the bulb.

11. The vehicle of claim 10, wherein the opening formed in the ceiling has a first perimeter and the outer support frame has a second perimeter, the second perimeter being greater than the first perimeter.

12. A sky light assembly for being coupled to a ceiling in a recreational vehicle, comprising:
a frame configured to being coupled to an opening formed in the ceiling;
a light fixture coupled to the frame, the light fixture comprising an outer support frame and an inner cavity;
a bulb disposed within the inner cavity, the bulb coupled to the light fixture; and
a mounting bracket configured to couple the light fixture to the frame.

13. The sky light assembly of claim 12, wherein the frame comprises a rectangular shape, a square shape, an oval shape, a circular shape, or polygonal shape.

14. The sky light assembly of claim 12, further comprising a control assembly including a controller and a power source, the power source being operably coupled to the controller;
wherein, the power source is electrically coupled to the bulb;
wherein, the controller is configured to control power to the bulb via the power source.

15. The sky light assembly of claim 14, further comprising a user control disposed in communication with the controller, the user control configured to control a transmittal of electrical power to the bulb.

16. The sky light assembly of claim 14, further comprising a sensor disposed in communication with the controller, the sensor configured to detect a characteristic and send a signal to the controller in response to the characteristic.

17. The sky light assembly of claim 16, wherein the controller is configured to control an amount of power delivered to the bulb based on the signal from the sensor.

18. The sky light assembly of claim 16, wherein the controller is configured to execute control logic to control an amount of power being sent from the power source to the bulb.

19. A recreational vehicle, comprising:
a chassis;
a body supported by the chassis and forming an interior of a living space, the body including one or more walls and a roof structure;
a ceiling located in the interior of the living space, the ceiling aligned but spaced from the roof structure to form a gap therebetween; and
a sky light assembly disposed within an opening formed in the ceiling and the roof structure, the sky light assembly comprising a frame, a light fixture, a bulb for illuminating the interior, a controller, a power source, and a mounting bracket;
wherein, the frame is coupled to the opening formed in the ceiling and roof structure;
wherein, the mounting bracket couples the frame and light fixture to one another;
wherein, the power source is operably coupled to the controller and electrically coupled to the bulb, where the controller is configured to control an amount of power transmitted to the bulb via the power source.

20. The recreational vehicle of claim 19, wherein the light fixture comprises an outer support frame and an inner cavity, where the bulb is disposed within the inner cavity and coupled to the light fixture.
